(19) United States
(12) Patent Application Publication
(10) Pub. No.: US 2015/0034256 A1
(43) Pub. Date: Feb. 5, 2015

(54) CURTAIN AND CURTAIN STRUCTURE PRODUCING METHOD

(71) Applicant: CHICOLOGY, INC., City of Industry, CA (US)

(72) Inventor: Ju-Huai CHEN, City of Industry, CA (US)

(73) Assignee: CHICOLOGY, INC., City of Industry, CA (US)

(21) Appl. No.: 13/955,805

(22) Filed: Jul. 31, 2013

(51) Int. Cl. E06B 9/44; B32B 37/00

(52) U.S. Cl. CPC E06B 9/44; B32B 37/0084
USPC 160/84.04; 156/291

(57) ABSTRACT

This invention is a curtain production method which comprises the following processes:
A. Provide a substrate 1 and a substrate 2.
B. Bond the first bonding point of substrate 2 to substrate 1.
C. Bond the second bonding point of substrate 2 to a selected point on substrate 1 to form a hollow structure; the distance between these two bonding points on substrate 1 is smaller than the distance between two bonding points on substrate 2.

At the same time this invention provides curtains produced by this curtain structure producing method. Therefore this invention also provides fast produced and low cost Roman curtain.

### BACKGROUND OF THE INVENTION

1. Field of the Invention

This invention is about a production method of curtain and curtain structure—especially a simple process to produce curtain and curtain structure of Roman curtain.

2. Description of the Related Art

There are many different kinds of curtain. It is very important to attract attention of the users.

Curtain with nice shape often requires complex production procedure, and sometimes requires hand-working. However hand-working is too slow for mass production. It is also difficult to control quality.

This invention provides a curtain and curtain structure production method to improve the prior art.

### SUMMARY OF THE INVENTION

This invention is a curtain production method which comprises the following processes:
A. Provide a substrate 1 and a substrate 2.
B. Bond the first bonding point of substrate 2 to substrate 1.
C. Bond the second bonding point of substrate 2 to a selected point on substrate 1 to form a hollow structure; the distance between these two bonding points on substrate 1 is smaller than the distance between two bonding points on substrate 2.

At the same time this invention provides curtains produced by this curtain structure producing method. Therefore this invention also provides fast produced and low cost Roman curtain.

### BRIEF DESCRIPTION OF THE DRAWINGS

The invention will be described according to the appended drawings in which:

FIG. 1 is the production processes of the curtain structure for the first practical example.

FIG. 2 is the production processes of the curtain structure for the second practical example.

FIG. 3 is the frontal view of the first practical curtain example

FIG. 4 is the A-A′ of the curtain cross section in the third drawing.

FIG. 5 is the frontal view of the second practical curtain example.

### DETAILED DESCRIPTION OF THE INVENTION

One of the purposes of this invention is to provide a kind of curtain which is composed by two substrates (such as fabric, nylon, plastic and silk, etc.) stacked together to form Roman curtain with stacking pattern.

Another purpose is to provide a curtain structure production method. By using a machine simply bonding (such as thermo compression bonding) two substrates, Roman curtain can be fast produced.

To achieve the above mentioned purposes or other purposes, this invention comprises the following processes:
A. Provide substrate 1 and 2.
B. Bond the first bonding point of substrate 2 to substrate 1.
C. Bond the second bonding point of substrate 2 to a selected point on substrate 1 to form a hollow structure; the distance between this bonding point and the first bonding point (of substrate 2) is smaller than the distance between second bonding point and the first bonding point of the second substrate.

To achieve the above mentioned purposes or other purposes, this invention provides a kind of curtain which can fold or expend. This curtain comprises substrates 1 and 2. Substrate 1 has multiple bonding points, and the distance between two bonding points next to each other is distance 1. Substrate 2 has multiple first bonding points and second bonding points, respectively. Each first bonding point is bonded to an odd order of bonding points on substrate 1 and each second bonding points is bonded to an even one. The first and the second bonding points are staggered. The distance between a first bonding point and a second bonding point next to it is distance 2. Distance 2 is larger than distance 1; therefore substrate 2 will form multiple hollow structures over substrate 1

Comparing to prior art, this invention for curtain and curtain structure production method uses simpler processes to produce Roman curtains with complex and nice structure.

### PREFERRED EMBODIMENT OF THE PRESENT INVENTION

In order to understand the purposes, characters and effects of this invention, examples and drawings are provided as the following for explanation:

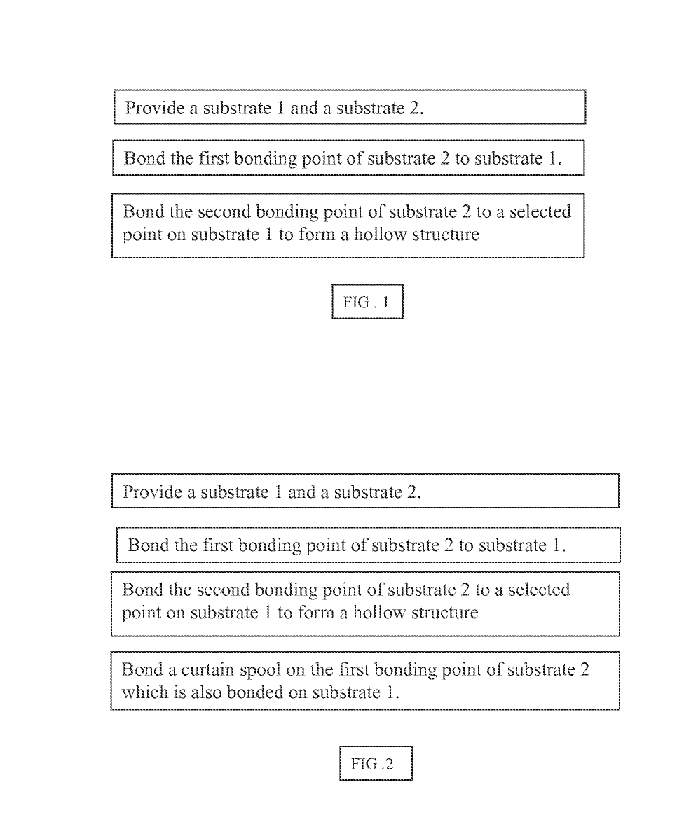

FIG. 1 is the production processes of the first practical example. This curtain structure producing method is used to produce Roman curtain.

The producing method starts with process S11—providing substrate 1 and 2. These substrates can be fabric, nylon, plastic, silk, etc.

Followed by process S12—bonding the first bonding point of substrate 2 to substrate 1. In this practical example, bonding is defined as fixing the first bonding point of substrate 2 to substrate 1 with any methods such as thermo compression bonding, glue bonding, etc.

Next is Process S13—select a bonding point on substrate 1 to bond the second bonding point of substrate 2. The distance between these two bonding points of substrate 1 is smaller than that of substrate 2. Therefore substrate 2 will form a hollow structure when it is bonded on substrate 1. The hollow structure can be adjusted by setting the value of these two distances of the two substrates.

By repeating processed A to C, multiple hollow structures can be formed between substrate 1 and 2. In another word, substrate 2 will form multiple hollow structures over substrate 1, and this kind of curtains is featured by multiple hollow structures.

FIG. 2 is the processes of the second practical example of this invention. These processes are used to produce Roman curtain.

In addition to process S11 to S13, there is process S14 in FIG. 2—bonding a curtain spool on the first bonding point of substrate 2 which is also bonded on substrate 1. This curtain spool is used to roll up both of substrates and to fold part of the material of the substrate 2 to the hollow structure.

After process S14, the curtain spool is used to roll up the curtain and compress the hollow structure formed by substrate 2, or to expand the curtain when rolling reverse.

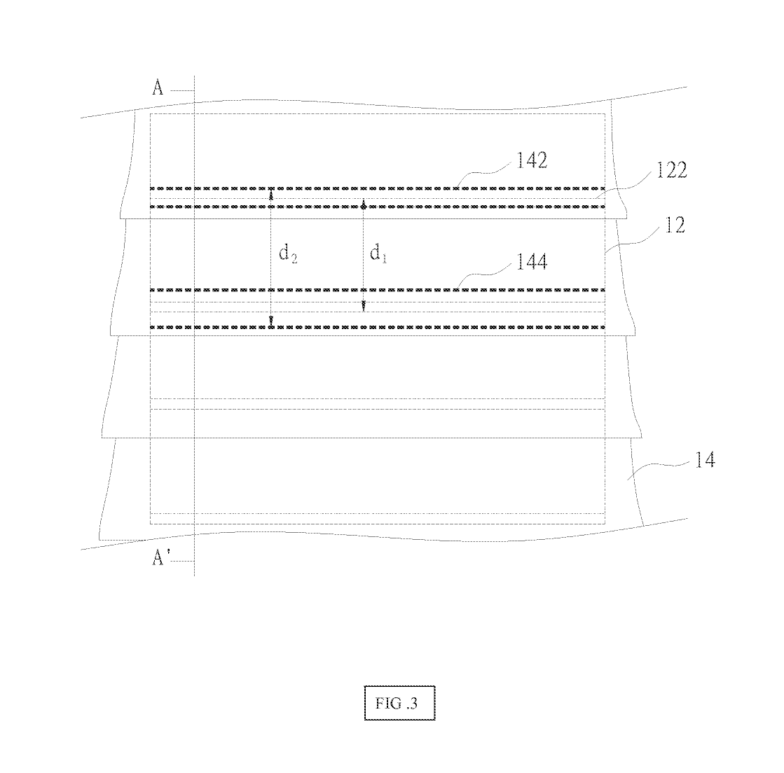

FIG. 3 is the frontal view of the first practical example of this invention. The curtain in FIG. 3 can be rolled up or expended.

This curtain (10) comprises substrate 1 (12) and second substrate 2 (14).

Substrate 1 (12) includes multiple bonding points (122). The distance between each bonding point (122) is the first distance (d1).

Substrate 2 (14) has multiple first bonding points (142) and second bonding points (144). Each first bonding point (142) is bonded to odd order of bonding point of substrate 1 (122) and each second bonding point (144) is bonded to even order of the same. Therefore 142 and 144 are staggered. The distance between 142 and the closest 144 is distance 2 (d2).

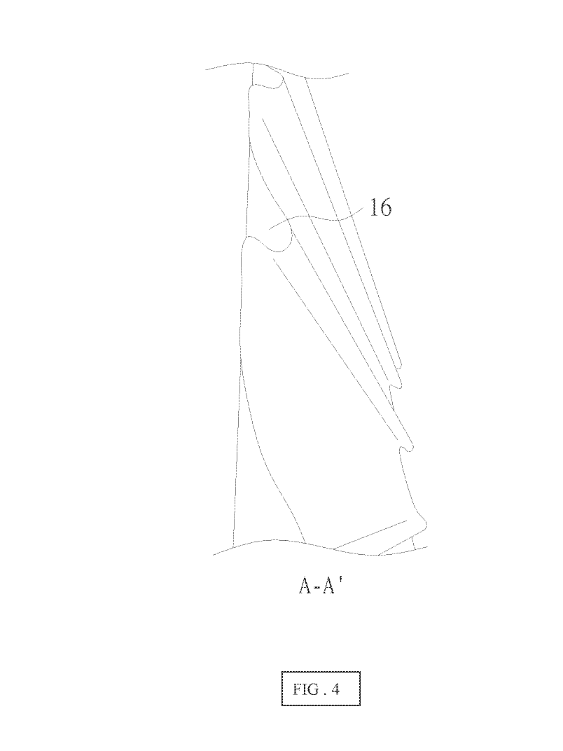

The above mentioned d2 is larger than d1, therefore substrate 2 (14) will form a hollow structure (16) on substrate 1 (12). Please refer to FIG. 4 to see the cross section (A-A′) of the hollow structure (16) of the curtain (10).

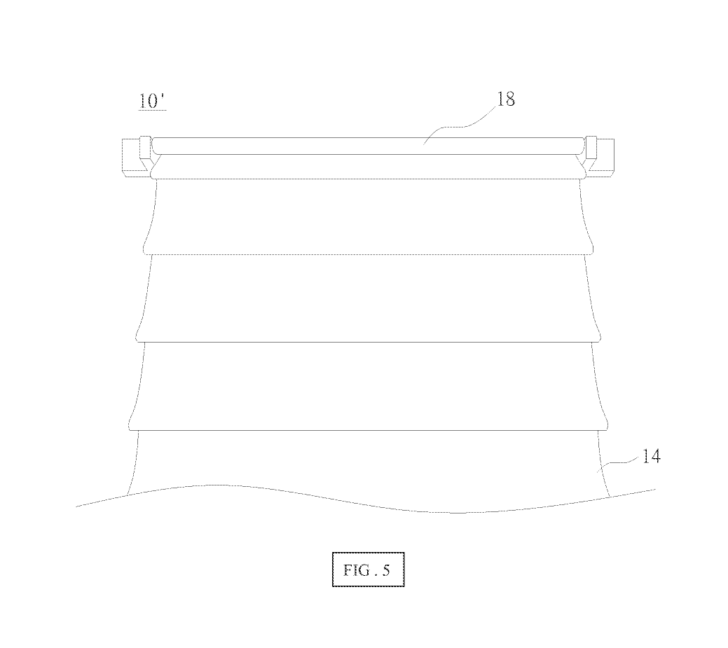

FIG. 5 is the frontal view of the second practical example of this invention. The curtain (10) in FIG. 5 comprises not only substrate 1 (12) and 2 (14) in FIG. 4, but also the curtain spool (18).

The curtain spool (18) is bonded to one end of the first substrate (12) for rolling it up. When substrate 1 (12) is folded, substrate 2 (14) is also folded accordingly. In another word, by reducing the first distance (d1), the bonding points 142 and 144 will move to each other, therefore the hollow structure (16) will be reduced.

Note that the bonding points (122) may have glue (not shown in this FIG.) on them in some cases to bond substrate 1 and 2.

The above-described embodiments of the present invention are intended to be illustrative only. Numerous alternative embodiments may be devised by persons skilled in the art without departing from the scope of the following claims.

What is claimed is:

1. A curtain producing method which comprises the following processes:
A. Provide substrate 1 and 2;
B. Bond the first bonding point of substrate 2 to substrate 1; and
C. Bond the second bonding point of substrate 2 to a selected point on substrate 1 to form a hollow structure; the distance between this bonding point and the first bonding point on substrate 1 is smaller than the distance between second bonding point and the first bonding point of substrate 2.

2. As the curtain producing processes in the claim 1, there is process D after process B, which is to bond a curtain spool to first bonding point of substrate 2 and substrate 1. The curtain spool is used to roll-fold the curtain.

3. in the process C of the claim 1, the first and the second bonding point of substrate 2 are bonded to the bonding points of substrate 1 by thermo compression bonding.

4. Multiple hollow structures can be formed between substrate 1 and 2 by repeating processes A to C in the claim 1.

5. A foldable/expandable curtain which comprises:
Substrate 1 which has multiple bonding points; the distance between one bonding point and the same next to it is distance 1,
Substrate 2 which has multiple first bonding points and second bonding points; each first bonding point is bonded to an odd order of the bonding points on substrate 1 and each second bonding point is bonded to an even one, therefore the first and the second bonding points are staggered. The distance between a first bonding point and a second bonding point next to it is distance 2.
Distance 2 is larger than distance 1; therefore substrate 2 will form multiple hollow structures over substrate 1.

6. The type of curtain described in claim 5 comprises a curtain spool. This spool is bonded to one end of substrate 1 in order to roll it up.

7. The curtain described in claim 6 is able to use its spool to decrease distance 1 therefore move the second bonding points toward first bonding points. This will reduce the hollow structure formed by each first bonding point and second bonding point.

8. There are glues on each bonding points for bonding substrate 1 and 2 in the curtain described in claim 5.
